(19) United States
(12) Patent Application Publication
(10) Pub. No.: US 2012/0068395 A1
(43) Pub. Date: Mar. 22, 2012

(54) ASSEMBLY FACILITATION APPARATUS AND METHOD

(76) Inventor: Bernd P. DAESCHNER, Fairview, PA (US)

(21) Appl. No.: 12/887,566

(22) Filed: Sep. 22, 2010

(51) Int. Cl. B23Q 1/25; B23Q 7/00

(52) U.S. Cl. 269/55; 29/559

(57) ABSTRACT

An assembly apparatus includes a frame and a contact structure connected to and supported by the frame. The contact structure is configured to receive and secure a workpiece having a plurality of working locations. The contact structure and the workpiece are capable of movement relative to the frame such that each working location of the workpiece has an assembly position proximate to an assembly substation and another position that is distal from the assembly substation, and such that the working location at its assembly position is substantially equidistant from assembly substation relative to the other working locations in their respective assembly positions.

### FIELD OF THE INVENTION

Embodiments of the invention relate generally to an assembly facilitation apparatus and method and, in particular, to an apparatus for facilitating the installation of gearbox bearings on a carrier plate.

### BACKGROUND OF THE INVENTION

Wind turbine systems are conventionally known. Such systems generally include a rotor head to which wind turbine blades are attached, a main shaft coupled to the rotor head so as to integrally rotate with the rotor head, a gear box coupled to the main shaft that rotates by means of wind power received by the wind turbine blades, and an electrical generator driven by an output shaft from the gear box. The gearbox and generator are typically housed in a nacelle mounted atop a tower.

In use, the wind turbine blades transform wind energy into a rotational torque or force that drives the electrical generator. The gearbox is used to step up the inherently slow rotation, high torque of the turbine rotor to a much higher rotation and lower torque for input into the electrical generator. In this manner, the gearbox provides a high speed, low torque output to the generator suitable for the production of electricity.

Conventional gear boxes for use with wind turbines can weigh several tons and typically contain numerous stages and gears to achieve an overall gear ratio from 40:1 to over 100:1, depending on the size of the turbine. As will be readily appreciated, assembling such large and heavy components found in wind turbine gearboxes presents several problems. For example, installing bearings on a carrier plate of a gearbox has proven difficult and time consuming. In addition, known methods for installing such bearings require frequent movement of the operator, which leads to inefficient assembly and increased build time. Accordingly, there is a need for an apparatus that facilitates the assembly of gearbox components and optimizes the time required to install bearings on a carrier plate to an extent previously unknown.

### BRIEF DESCRIPTION OF THE INVENTION

According to one embodiment of the present invention, an assembly apparatus includes a frame and a contact structure connected to and supported by the frame. The contact structure is configured to receive and secure a workpiece having a plurality of working locations. The contact structure and workpiece are capable of movement relative to the frame such that each working location of the plurality of working locations of the workpiece has an assembly position proximate to an assembly substation and another position that is distal from the assembly substation, and the working location at its assembly position is substantially equidistant from the assembly substation relative to the other working locations in their respective assembly positions. Thereby, in one aspect, a component can be moved from the assembly substation to the working location in the assembly position along either a path of substantially equal distance or during a substantially same amount of travel time. “Substantially,” in one aspect, means at or within plus or minus 5%, to account for inconsequential variations. In another aspect, each working location at its assembly position is exactly equidistant, meaning the same distance but for manufacturing tolerances (exactly equidistant is a subset of substantially equidistant). “Proximate” means that the assembly position is closer to the assembly substation than the another position of the working location, and close enough for transfer (e.g., manual transfer without an operator having to move more than several feet or one meter) of the component from the assembly substation to the working location.

According to another embodiment of the present invention, a method of assembling a gearbox includes placing a carrier plate having a plurality of working locations on a contact structure, positioning the contact structure relative to the frame until a first working location is proximate to an assembly substation in an assembly position, transferring a component from the assembly substation to the first working location that is in the assembly position, securing the component to the first working location of the carrier plate, and rotating the contact structure further until the first working location is not in the assembly position.

### BRIEF DESCRIPTION OF THE DRAWINGS

The present invention will be better understood from reading the following description of non-limiting embodiments, with reference to the attached drawings, wherein below:

FIG. 1 is an isometric view of a frame of an assembly apparatus in accordance with an embodiment of the inventive apparatus for facilitating the installation of bearings into a carrier plate.

FIG. 2 is a side elevational view of the frame of the assembly apparatus of FIG. 1.

FIG. 3 is an isometric view of a contact structure of the assembly apparatus in accordance with an embodiment of the inventive apparatus for facilitating the installation of bearings into a carrier plate.

FIG. 4 is a side elevational view of the contact support structure of the assembly apparatus of FIG. 3.

FIG. 5 is a top plan view of the assembly apparatus in accordance with an embodiment of the inventive apparatus for facilitating the installation of bearings into a carrier plate.

FIG. 6 is a schematic view of the assembly apparatus of FIG. 3 showing a plurality of working locations thereof in relation to an assembly substation in accordance with an embodiment of the present invention.

FIG. 7 is a flowchart illustrating the steps of a method for assembling a gearbox in accordance with an embodiment of the present invention.

### DETAILED DESCRIPTION OF THE INVENTION

Reference will be made below in detail to exemplary embodiments of the invention, examples of which are illustrated in the accompanying drawings. Wherever possible, the same reference numerals used throughout the drawings refer to the same or like parts.

As described in detail below, an embodiment of the present invention provides an assembly apparatus for facilitating the installation of bearings into a carrier plate of a gearbox for use in wind turbine systems, and which optimizes the value added time to install the bearings and reduces excess movement of the operator. Embodiments of the inventive apparatus include beneficial loading and alignment features, as well rotating and adaptor mechanisms.

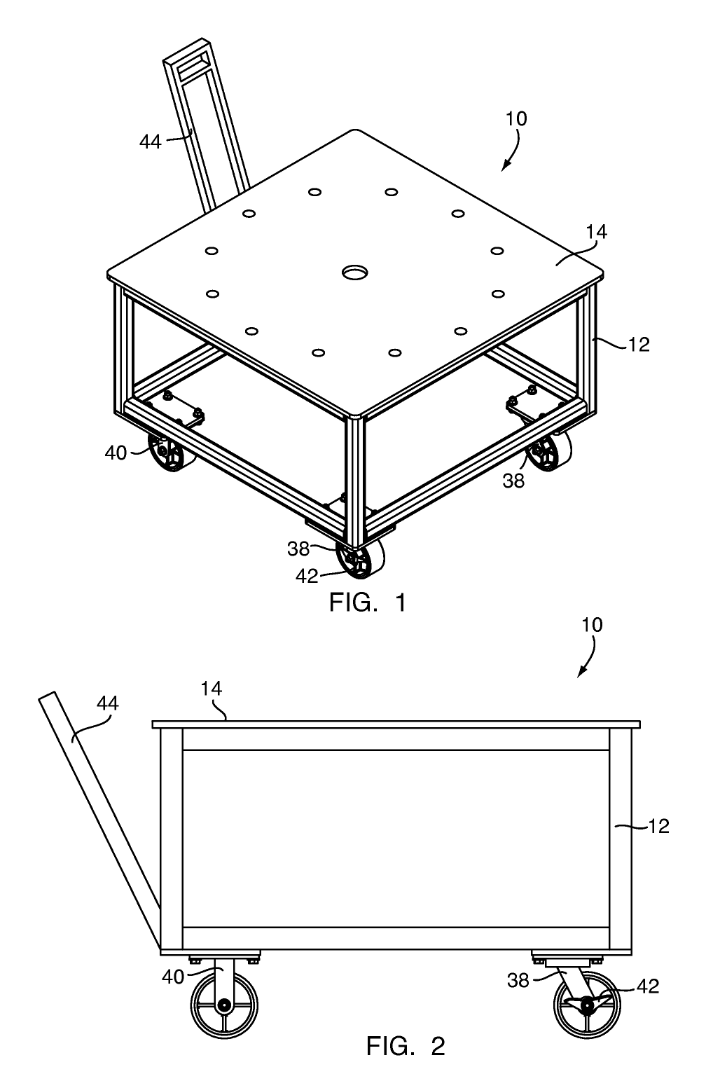

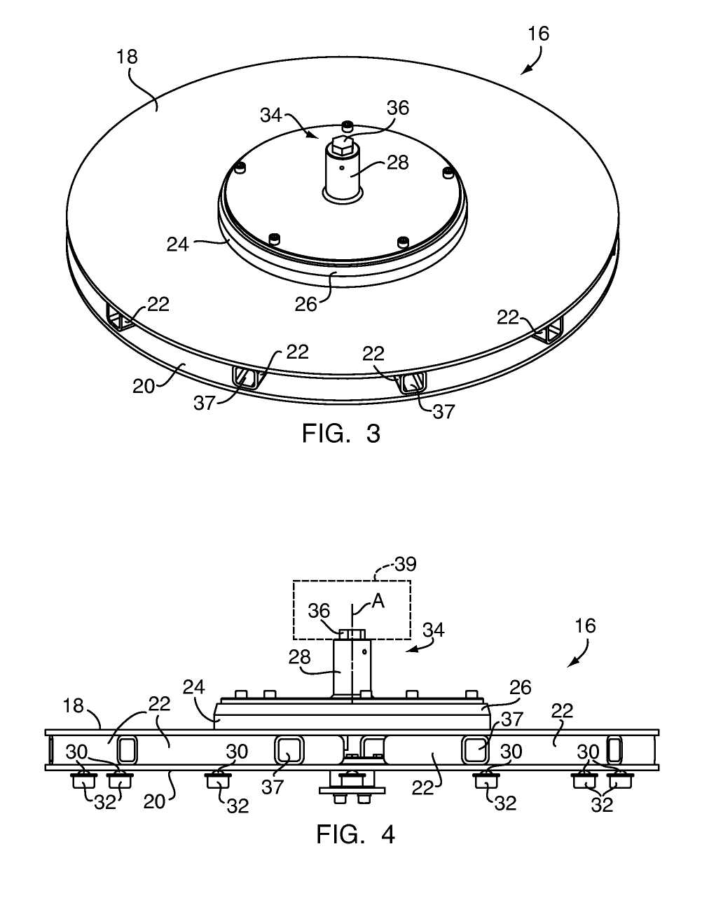

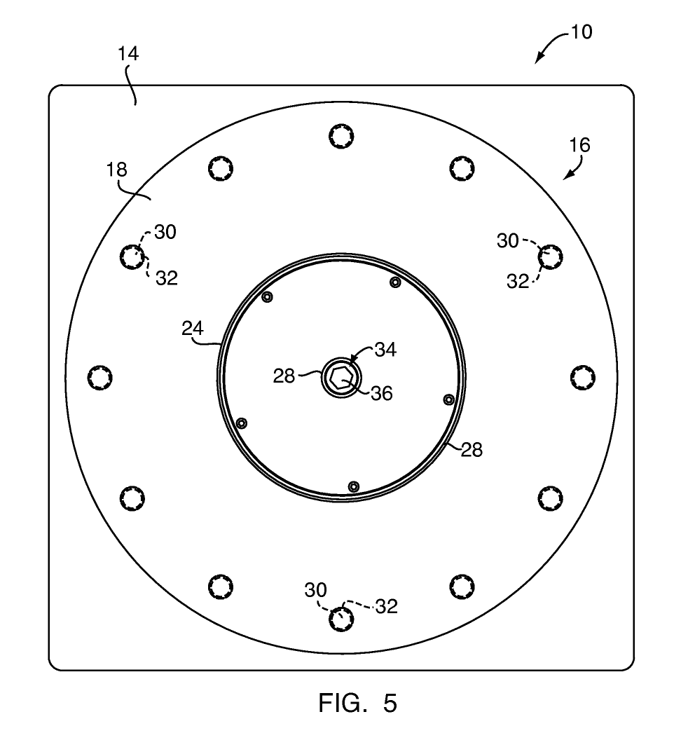

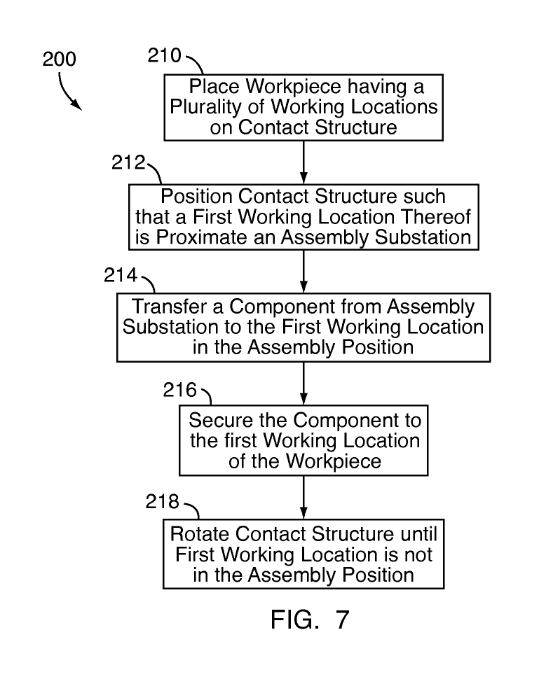

Referring generally to FIGS. 1-7, an embodiment of the assembly apparatus 10 of the present invention generally takes the form of a cart and includes a frame 12 having a generally planar upper surface 14 attached thereto. A contact structure 16, best shown in FIGS. 3 and 4, is operatively connected to upper surface 14 and is supported by the frame 12. The frame 12 is formed from a plurality of metal rails arranged so as to form a generally rectangular box and suitable to support the weight of a workpiece, C, such as a carrier plate for use in a wind turbine gear box. In particular, frame 12 is configured to support a weight of at least 1,500-2,000 lbs., although other materials, heavier-duty rails and alternative frame configurations may be employed to support carrier plates and associated components of greater weight. The box-shape frame 12 may also include bracing components and/or cross-members for added frame stability, support and safety.

The contact structure 16 is generally circular in shape and comprises an upper plate portion 18, a lower plate portion 20, and a plurality of radially extending square support beams 22. The contact structure 16 is configured to receive and support a workpiece, C, having a plurality of working locations, W. As noted, the workpiece may be a carrier plate in which case the working locations, W, of the carrier plate are configured to receive a component bearing race from an assembly substation, S.

In an embodiment, the apparatus 10 also includes an adaptor 24 releasably attached to the contact structure 16. The adaptor 24 allows the contact structure 16 to receive and secure a variety of different workpieces that may vary in size and/or shape, e.g., various size adaptor plates 24 may be secured to the contact structure 16 to accommodate workpieces having bores of different sizes. As shown therein, the adaptor 24 is generally circular in shape and has a chamfered or tapered annular surface 26 that facilitates alignment of the workpiece with the contact structure 16. The chamfer is approximately a fifteen degree chamfer, although other chamfer angles are also possible. In addition, a contact structure shaft 28 is fixedly attached to the contact structure 16 and extends substantially vertically therefrom. The contact structure shaft 28 defines an axis, A, about which the contact structure 16 is configured to rotate, as described below.

The assembly apparatus 10 further includes a plurality of ball transfers or the like positioned in apertures in upper surface 14 and located between the contact structure 16 and the frame 12. The ball transfers may include a bearing 30 disposed in a cup-like structure 32, and facilitate movement of the contact structure 16 relative to the frame 12. In particular, the ball transfers permit the contact structure 16 to rotate relative to the frame 12 such that each working location, W, of the of the workpiece, C, has an assembly position (generally indicated by P1) proximate to the assembly substation, S, and another position (generally indicated by P2) that is distal from the assembly substation, and the working location at its assembly position is substantially equidistant from the assembly substation relative to the other working locations in their respective assembly positions, whereby a component can be moved from the assembly substation to a working location in the assembly position along either a path of equal distance or during the same amount of travel time. As will be readily appreciated, the contact structure 16 is capable of rotating about the contact structure shaft axis relative to the frame 12 to position the working location of the workpiece proximate the assembly substation. The upper surface has twelve apertures to accommodate twelve bearing transfers to allow rotation of the contact structure 16, although more or fewer bearings can be used and the diameters thereof can be varied or changed based on specific component parameters.

The assembly apparatus further includes an actuation mechanism that is operable to move the contact structure 16 relative to the frame 12 such that each working location may be moved from its assembly position to another position. In one embodiment, the actuation mechanism is a polygonal nut assembly 34 operably connected to the contact structure. As shown in FIG. 3, the nut assembly includes a polygonal head, hex head, etc. portion 36 on the contact structure shaft. In this embodiment a socket wrench can receive the nut assembly head 36 to drive rotation of the contact structure 16. Alternatively, the support beams 22 may include an open end or aperture 37 in which a lever may be received to selectively to move, such as by rotation, the contact structure 16 relative to the frame 12. In yet another embodiment, the actuation mechanism comprises a motor 39 operable to move the contact structure 16 relative to the frame 12, such as by engagement with the polygonal nut assembly 34.

In addition to the above, an embodiment of the assembly apparatus 10 may be fitted with a plurality of swivel casters or other wheels for supporting the assembly apparatus 10 and for facilitating movement thereof. The wheels (e.g., swivel casters) may be attached to an underside of the frame by hex bolts, washers and nuts, although other attachment means known in the art may also be used. In particular, the apparatus 10 may have two swivel casters 38 and two rigid casters 40. A wheel locking mechanism or braking mechanism 42 may be coupled to at least one of the plurality of wheels (e.g., swivel casters) 38, 40 to enable a user to lock the apparatus 10 in place so that it will not roll or move from its set location. As with the swivel casters, the braking mechanism may be fixedly attached to the underside of the frame by hex bolts, washers and nuts, although other attachment means known in the art may also be used.

Referring now to FIGS. 1 and 2, the assembly apparatus 10 also has an attachment mechanism, such as a tongue hitch 44, which may be pivotally attached to the apparatus 10. The attachment mechanism allows the apparatus 10 to be attached to motive power or to another assembly apparatus or cart.

In operation, a carrier plate having a plurality of working locations is placed on the contact structure 16 of the assembly apparatus 10. The contact structure 16 is rotated or moved relative to the frame 12 until a first working location of the plurality of working locations, W is proximate to an assembly substation, S, in an assembly position. At the assembly substation, a temperature of a component may be modified to facilitate installation. The component, such as a bearing race, is then transferred from the assembly substation, S, to the first working location that is in the assembly position. The component is secured to the first working location of the carrier plate and the contact structure 16 is rotated further in the direction of arrow R until the first working location is no longer in the assembly position.

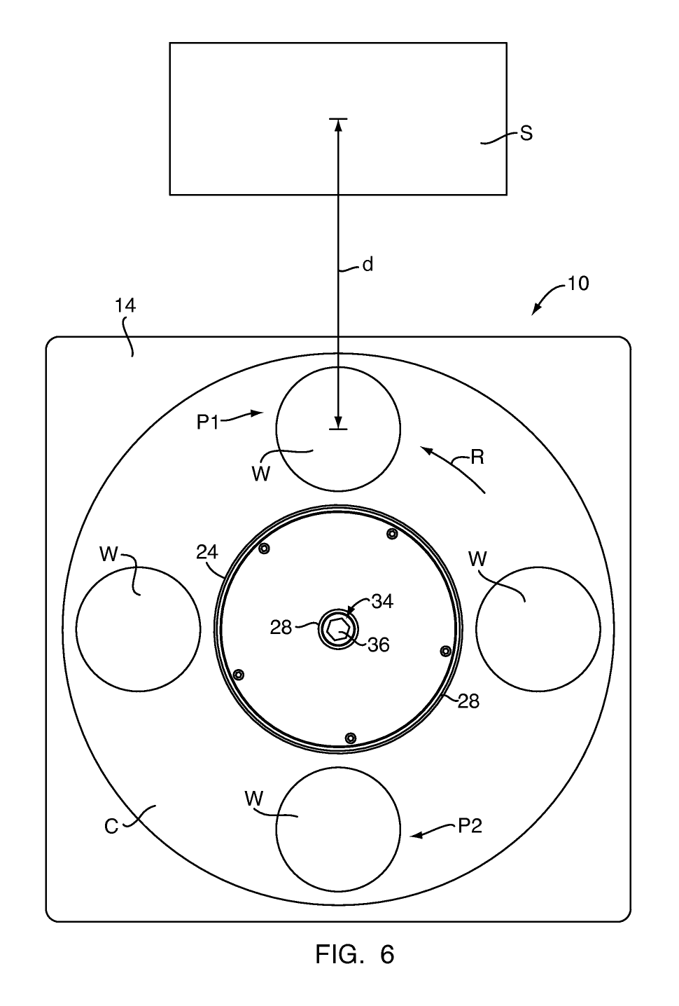

As will be readily appreciated, the contact structure 16 can be rotated further such that a second working location is brought into the assembly position proximate the assembly substation so that another bearing race may be aligned and seated on a second carrier plate working location. As shown in FIG. 6, the apparatus 10 of the present invention allows each component to travel substantially the same distance, d, from the assembly substation, S, to the each working location, W. This process may be repeated such that a component may be transferred from the assembly substation, S, to each carrier plate working location in substantially the same amount of time until each working location has a corresponding component disposed therein.

As discussed above, a motor may be signaled to effectuate rotation of the contact structure 16 to present each working location, W, to the assembly substation, S. for the transfer of a component. Alternatively, a socket wrench or the like, or a lever arm and corresponding aperture, may be used to rotate the contact structure 16.

The contact structure 16 may be manually or automatically rotated to successively present the working locations, W, of the carrier plate to the operator, as best shown in FIG. 6. This is especially useful due to assembly constraints with carrier plate/bearing race installation where the bearing race and/or other components are often cooled to shrink the components prior to install and there is a need to get the part from the freezer or cooling chamber to the install location and get it installed before heating of the component occurs. As will be readily appreciated, a static location of the component and the freezer means different travel distances from the freezer to the component install locations, which introduces variability in assembly and tolerances. With the present invention, however, rotating the part into position allows for identical travel paths for each cooled/frozen component, as discussed above. As embodiments of the present invention provide for an identical the travel path for each component, the temperature of each component at the time of assembly into the carrier plate is the same.

In use, an embodiment of the inventive apparatus may include a frame and a contact structure connected to and supported by the frame and configured to receive and secure a workpiece having a plurality of working locations. In other embodiments, the apparatus may include, in addition to the above, some or all of an actuation mechanism to move the contact structure relative to the frame, a plurality of wheels supporting the frame and a wheel locking mechanism coupled to the wheels, a braking mechanism coupled to at least one of the wheels, and a plurality of bearings for facilitating movement of the contact support structure relative to the frame.

Moreover, an adaptor for allowing the contact structure to receive and secure a workpiece of differing sizes and/or shapes may be included. The adaptor may optionally have a chamfered annular surface for facilitating alignment of the workpiece with the contact structure.

In yet other embodiments, the actuation mechanism may include at least one aperture located on a surface of the contact structure and a lever which may be selectively placed within the aperture to move the contact structure. The actuation mechanism may alternatively include a polygonal nut assembly connected to the contact support structure that responds to applied torque by moving the contact structure. Moreover, the actuation mechanism may include a motor operable to move the contact structure relative to the frame.

In an embodiment, the assembly apparatus may be a gearbox, the workpiece a carrier plate, and the component a bearing race.

An embodiment of the present invention contemplates a method 200 of assembling a gearbox. The method includes the step 210 of placing a carrier plate having a plurality of working locations on a contact structure, the contact structure being operatively connected to a frame, the step 212 of positioning the contact structure relative to the frame until a first working location of the plurality of working locations is proximate an assembly substation in an assembly position, step 214 of transferring a component from the assembly substation to the first working location that is in the assembly position, step 216 of securing the component to the first working location of the carrier plate, and the step 218 of rotating the contact structure further until the first working location is not in the assembly position.

The method may additionally include the step or steps of modifying the temperature of the component at the assembly substation and/or signaling a motor to rotate the contact support structure. In yet other embodiments, rotating the contact structure includes rotating a second working location into the assembly position, and transferring the component includes completing a path of the component from the assembly substation to the working location in the assembly position in an amount of time that is substantially the same for each component so transferred until each of the working locations has a corresponding component disposed therein.

In an embodiment, an assembly apparatus includes a frame and a contact structure connected to and supported by the frame. The contact structure is configured to receive and secure a workpiece having a plurality of working locations. The contact structure and workpiece are configured to move relative to the frame such that each working location of the plurality of working locations of the workpiece has an assembly position proximate to an assembly substation and another position that is distal from the assembly substation, and the working location at its assembly position is substantially equidistant from the assembly substation relative to the other working locations in their respective assembly positions. Thereby, in one aspect, a component can be moved from the assembly substation to the working location in the assembly position along either a path of substantially equal distance or during a substantially same amount of travel time.

An embodiment relates to an assembly apparatus for assembling bearing races on a carrier plate of a wind turbine gearbox. The apparatus comprises a frame and a contact structure operatively connected to and supported by the frame. The contact structure is configured to receive and secure a carrier plate having a plurality of working locations for receiving bearing races from an assembly substation. Additionally, the contact structure and the carrier plate are configured to move relative to the frame such that each working location of the plurality of working locations of the carrier plate has an assembly position proximate to the assembly substation and another position that is distal from the assembly substation. The working location of the carrier plate at its assembly position is substantially equidistant from the assembly substation relative to the other working locations in their respective assembly positions. The bearing races can be moved from the assembly substation to the working location of the carrier plate in the assembly position along either a path of substantially equal distance or during a substantially same amount of travel time.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled.

In the appended claims, the terms “including” and “in which” are used as the plain-English equivalents of the respective terms “comprising” and “wherein.”Moreover, in the following claims, the terms “first,” “second,” “third,” “upper,” “lower,” “bottom,” “top,” “up,” “down,” etc. are used merely as labels, and are not intended to impose numerical or positional requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose several embodiments of the invention, including the best mode, and also to enable any person skilled in the art to practice the embodiments of invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

Since certain changes may be made in the above-described embodiments, without departing from the spirit and scope of the invention herein involved, it is intended that all of the subject matter of the above description or shown in the accompanying drawings shall be interpreted merely as examples illustrating the inventive concept herein and shall not be construed as limiting the invention.

What is claimed is:

1. An assembly apparatus, the apparatus comprising:
a frame;
a contact structure operatively connected to and supported by the frame, the contact structure being configured to receive and secure a workpiece having a plurality of working locations; and
wherein the contact structure and the workpiece are capable of movement relative to the frame such that each working location of the plurality of working locations of the workpiece has an assembly position proximate to an assembly substation and another position that is distal from the assembly substation, and the working location at its assembly position is substantially equidistant from the assembly substation relative to the other working locations in their respective assembly positions, whereby a component can be moved from the assembly substation to the working location in the assembly position along either a path of substantially equal distance or during a substantially same amount of travel time.

2. The assembly apparatus of claim 1, further comprising an actuation mechanism that is operable to move the contact structure relative to the frame.

3. The assembly apparatus of claim 2, wherein the actuation mechanism comprises:
at least one aperture located on a surface of the contact structure; and
a lever which may be selectively placed within the aperture to move the contact structure.

4. The assembly apparatus of claim 2, wherein the actuation mechanism comprises:
a polygonal nut assembly operably connected to the contact structure; and
wherein the polygonal nut assembly responds to applied torque by moving the contact structure.

5. The assembly apparatus of claim 2, wherein the actuation mechanism comprises a motor operable to move the contact structure relative to the frame.

6. The assembly apparatus of claim 1, further comprising a plurality of wheels supporting the frame, and a wheel locking mechanism coupled to at least one of the plurality of wheels.

7. The assembly apparatus of claim 6, further comprising a braking mechanism coupled to at least one of the plurality of wheels.

8. The assembly apparatus of claim 1, further comprising an attachment mechanism allowing the apparatus to be attached to motive power or another assembly apparatus.

9. The assembly apparatus of claim 1, further comprising a plurality of bearings located between the contact structure and frame, the bearings facilitating movement of the contact structure relative to the frame.

10. The assembly apparatus of claim 1, further comprising an adaptor in operative association with the contact structure, the adaptor allowing the contact structure to receive and secure a workpiece from a plurality of workpieces of differing sizes, shapes, or both sizes and shapes.

11. The assembly apparatus of claim 10, wherein the adaptor has a chamfered annular surface facilitating alignment of the workpiece with the contact structure.

12. The assembly apparatus of claim 1, wherein the contact structure is configured to rotate about an axis relative to the frame to position the working location of the workpiece proximate an assembly substation.

13. The assembly apparatus of claim 1, wherein the assembly apparatus is a gearbox, the workpiece is a carrier plate, and the component is a bearing race.

14. The assembly apparatus of claim 13, wherein the bearing race seats in the carrier plate and has a surface that is not flush with a carrier plate surface, further comprising an adaptor that is configured to contact and support the bearing race.

15. A method of assembling a gearbox, comprising:
placing a carrier plate having a plurality of working locations on a contact structure, the contact structure being operatively connected to a frame;
positioning the contact structure relative to the frame until a first working location of the plurality of working locations is proximate an assembly substation in an assembly position;
transferring a component from the assembly substation to the first working location that is in the assembly position;
securing the component to the first working location of the carrier plate; and
rotating the contact structure further until the first working location is not in the assembly position.

16. The method as defined in claim 15, wherein rotating the contact structure further comprises rotating a second working location into the assembly position.

17. The method as defined in claim 16, further comprising modifying the temperature of the component at the assembly substation.

18. The method as defined in claim 17, wherein transferring the component comprises completing a path of the component from the assembly substation to the working location in the assembly position in an amount of time that is substantially the same for each component so transferred until each of the working locations has a corresponding component disposed therein.

19. The method as defined in claim 18, wherein a temperature of the component at a time of assembly into the carrier plate is the same for each assembled component.

20. An assembly apparatus for assembling bearing races on a carrier plate of a wind turbine gearbox, the apparatus comprising:
a frame; and
a contact structure operatively connected to and supported by the frame, the contact structure being configured to receive and secure a carrier plate having a plurality of working locations for receiving bearing races from an assembly substation;
wherein the contact structure and the carrier plate are configured to move relative to the frame such that each working location of the plurality of working locations of the carrier plate has an assembly position proximate to the assembly substation and another position that is distal from the assembly substation, and the working location of the carrier plate at its assembly position is substantially equidistant from the assembly substation relative to the other working locations in their respective assembly positions, and wherein the bearing races can be moved from the assembly substation to the working location of the carrier plate in the assembly position along either a path of substantially equal distance or during a substantially same amount of travel time.
